(19) United States
(12) Patent Application Publication
(10) Pub. No.: US 2010/0206801 A1
(43) Pub. Date: Aug. 19, 2010

(54) FILTERING BASKET FOR FIBRES IN WATER DISPERSION

(75) Inventor: Giancarlo Dal Maso, Schio (IT)

Correspondence Address: COOK ALEX LTD, SUITE 2850, 200 WEST ADAMS STREET, CHICAGO, IL, 60606, US

(73) Assignee: Comer S.p.A., San Vito Di Leguzzano (IT)

(21) Appl. No.: 12/669,062

(22) PCT Filed: Jul. 31, 2008
(86) PCT No.: PCT/EP2008/060103

§ 371 Date: Feb. 26, 2010

(30) Foreign Application Priority Data
Jul. 31, 2007 (IT) VI2007A000209

(51) Int. Cl. B01D 35/28

(52) U.S. Cl. 210/485

(57) ABSTRACT

The invention is a filtering basket for fibres in water dispersion, comprising a plurality of profiled bars arranged side by side to define a tubular structure with the inner lateral surface provided with a plurality of longitudinal slots that define a filtering surface; two or more annular elements coaxial to one another and spaced from one another, coupled by interference outside the profiled bars. The profiled bars comprise a plurality of main bars, each one of which is provided with a shaped edge whose cross-section is in the form of a trapezium and has the long side facing towards the inside of the basket and a plurality of secondary bars, each one of which is provided with a shaped edge whose cross-section is curved, with the convex part facing towards the inside of the basket.

The invention concerns an improved filtering basket suited to be installed in systems for filtering fibres in water dispersion.

As is known, in the paper industry water dispersions containing cellulose fibres—mainly those derived from recovered paper—before being used in the production process must be properly filtered in order to eliminate all the impurities contained therein.

Filtering is carried out by means of the known strainers that substantially comprise a fixed filtering basket made of stainless steel and constituted by a plurality of metal bars that develop mainly in a longitudinal direction, positioned side by side in order to define a tubular structure.

The bars are provided with shaped edges that are substantially in the form of a trapezium, circumferentially spaced from one another in such a way as to define, on the inner lateral surface of the basket, a plurality of properly sized longitudinal slots whose widths are in the order of fractions of millimetre.

The inner lateral surface of the basket thus becomes the filtering surface.

Outside the bars there are annular elements coaxially spaced from one another that block them and maintain the tubular shape of the basket unaltered.

Inside the basket there is a rotor that sets the dispersion moving, so that the dispersion, while passing through the sized slots, releases the impurities present therein.

The filtering baskets having the characteristics described above and belonging to the known art, however, pose some recognized drawbacks.

A first recognized drawback lies in that their filtering action cannot exceed certain maximum values.

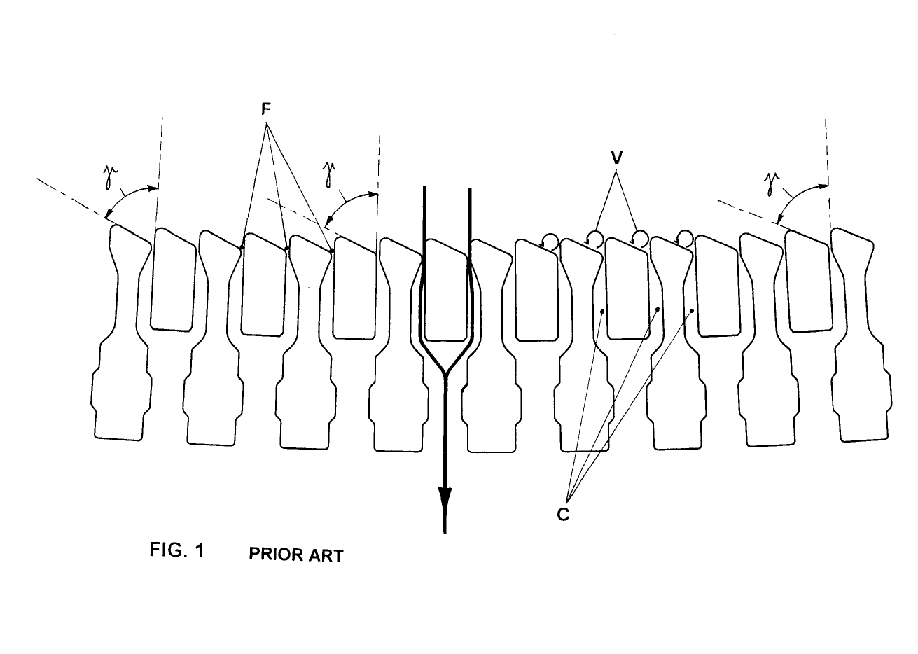

It is known, in fact, that, with reference to FIG. 1, filtering takes place because the rotor, during its rotation, sets the dispersion in movement and generates a vortex V at the height of the slots F.

The formation of such vortex V, in combination with the converging-diverging profile of the channel C defined by the profiles of the bars at the level of the slots F, produces the filtering action due to the known Venturi effect.

Furthermore, it has been found out that in order to obtain the formation of an optimal vortex the dimensions of the shaped edges of the bars must not be below certain pre-established values and therefore they are carried out in substantially standard sizes.

There is therefore a limit for the maximum thickness of the slots present in the basket per unit of length of the lateral surface and this represents a limitation to the filtering capacity of the baskets of known type.

Another limitation is represented by the fact that all the slots F present the same inlet angle γ as shown in FIG. 1 and this means that their filtering capacity is not differentiated according to the different length of the fibres to be filtered.

The present invention intends to overcome the drawbacks described above.

In particular, it is a first object of the invention to manufacture a filtering basket for filtering fibres in water dispersion that compared to filtering baskets of known type having the same size features thicker filtering slots.

It is another object of the invention to manufacture a basket that, compared to filtering baskets of known type, has a differentiated filtering capacity, such as to obtain better selection of the fibres to be accepted and to be rejected.

The objects described above have been achieved through the construction of a filtering basket whose characteristics are in accordance with the contents of the main claim.

Other characteristics of the basket of the invention are described in the dependent claims.

Advantageously, the basket that is the subject of the invention ensures more efficiency and better filtering quality than the baskets of known type having the same size.

The objects and advantages described above will be highlighted in greater detail in the description of preferred embodiments of the invention that are illustrated as examples without limitation in the enclosed drawings, wherein:

FIG. 1 shows a partial schematic section of a filtering basket constructed according to the known art, carried out orthogonally to the longitudinal axis of the basket;

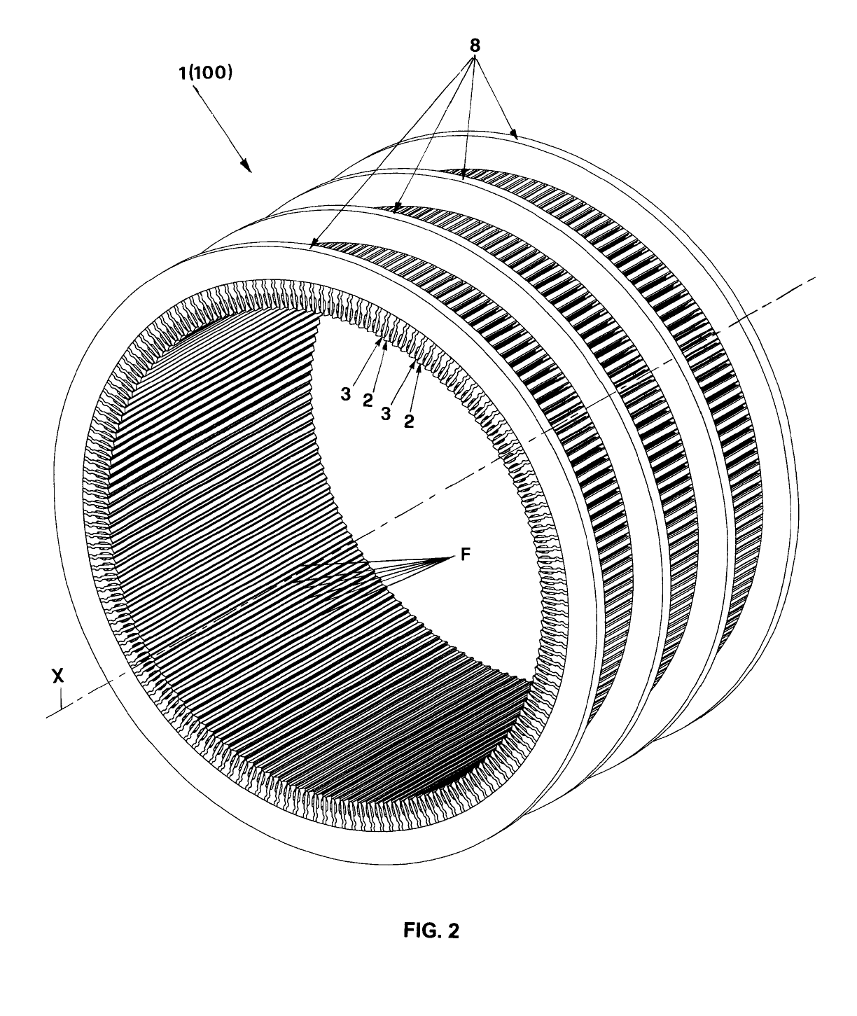

FIG. 2 shows an axonometric view of the filtering basket that is the subject of the invention;

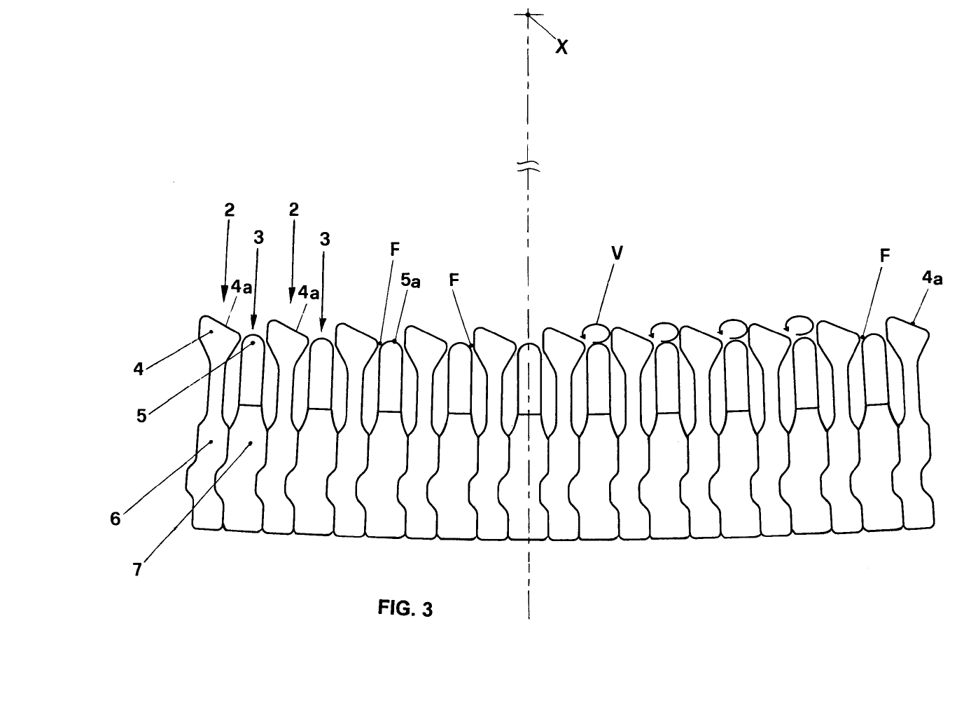

FIG. 3 shows a partial schematic section of the filtering basket shown in FIG. 1, carried out orthogonally to the longitudinal axis of the basket;

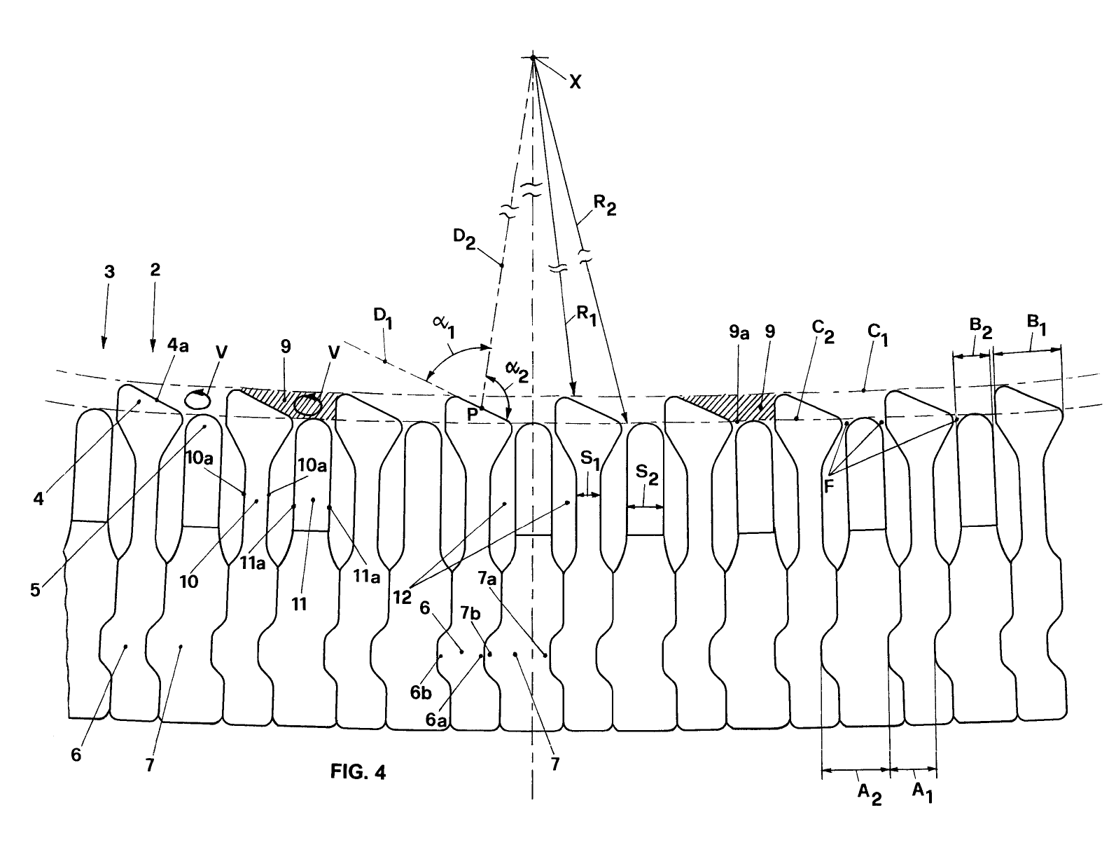

FIG. 4 shows an enlarged view of the section of FIG. 3;

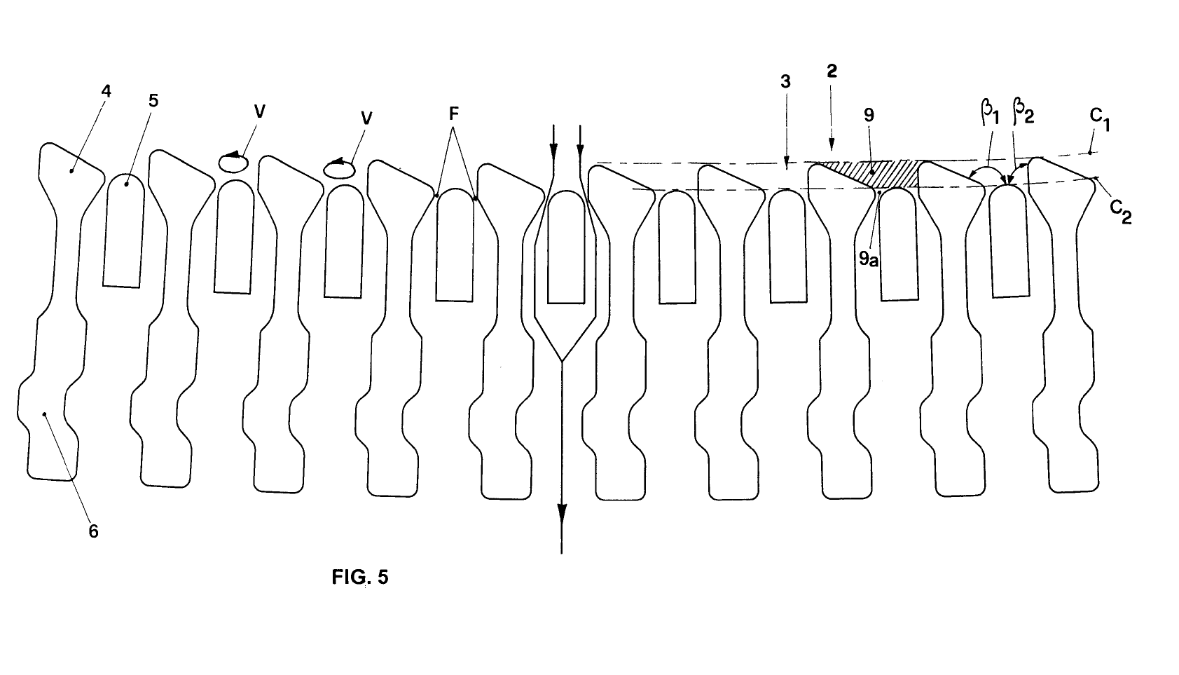

FIG. 5 shows another partial and schematic section of the filtering basket that is the subject of the invention, carried out orthogonally to the longitudinal axis of the basket;

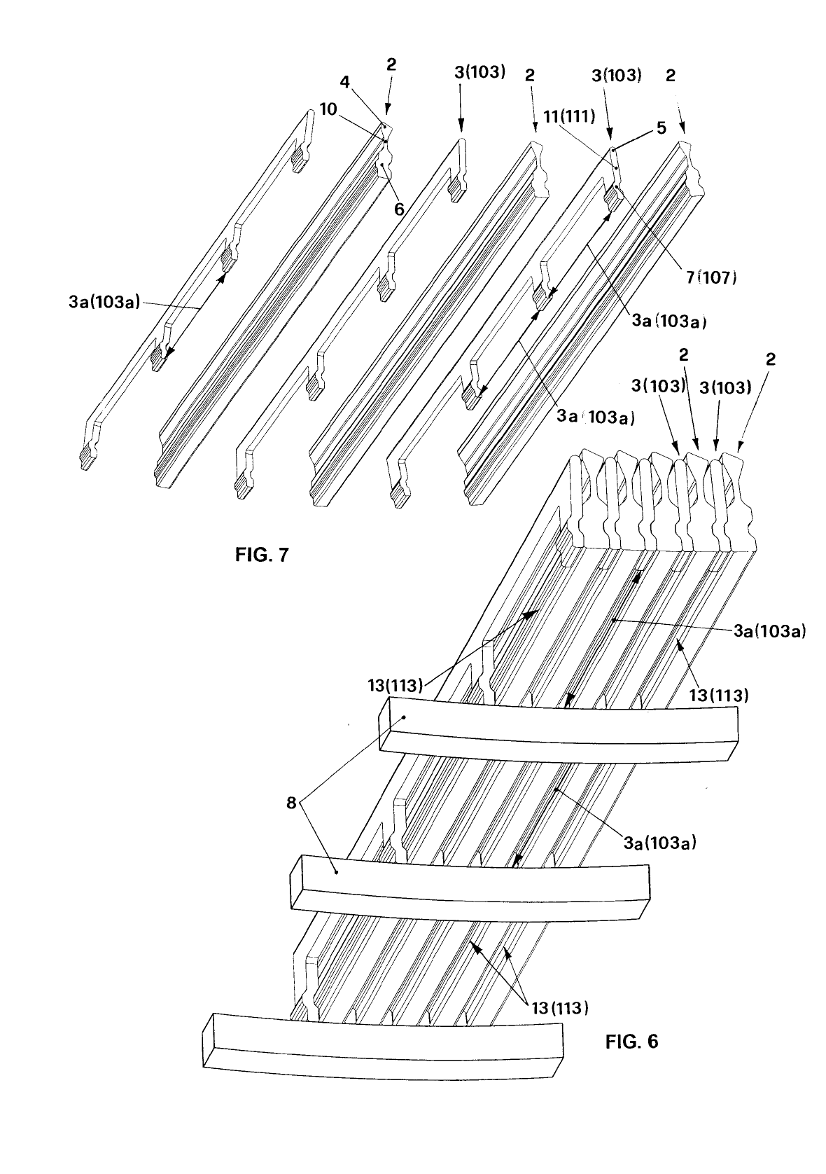

FIG. 6 shows an axonometric view of an enlarged detail of the basket of the invention;

FIG. 7 shows some disassembled elements of the part shown in FIG. 6;

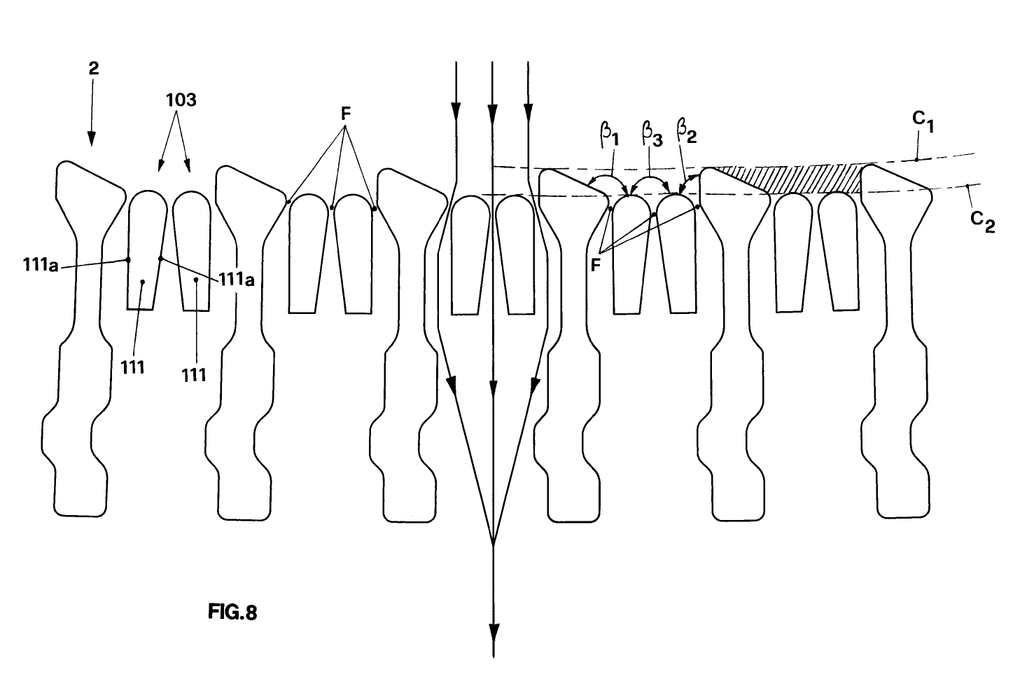

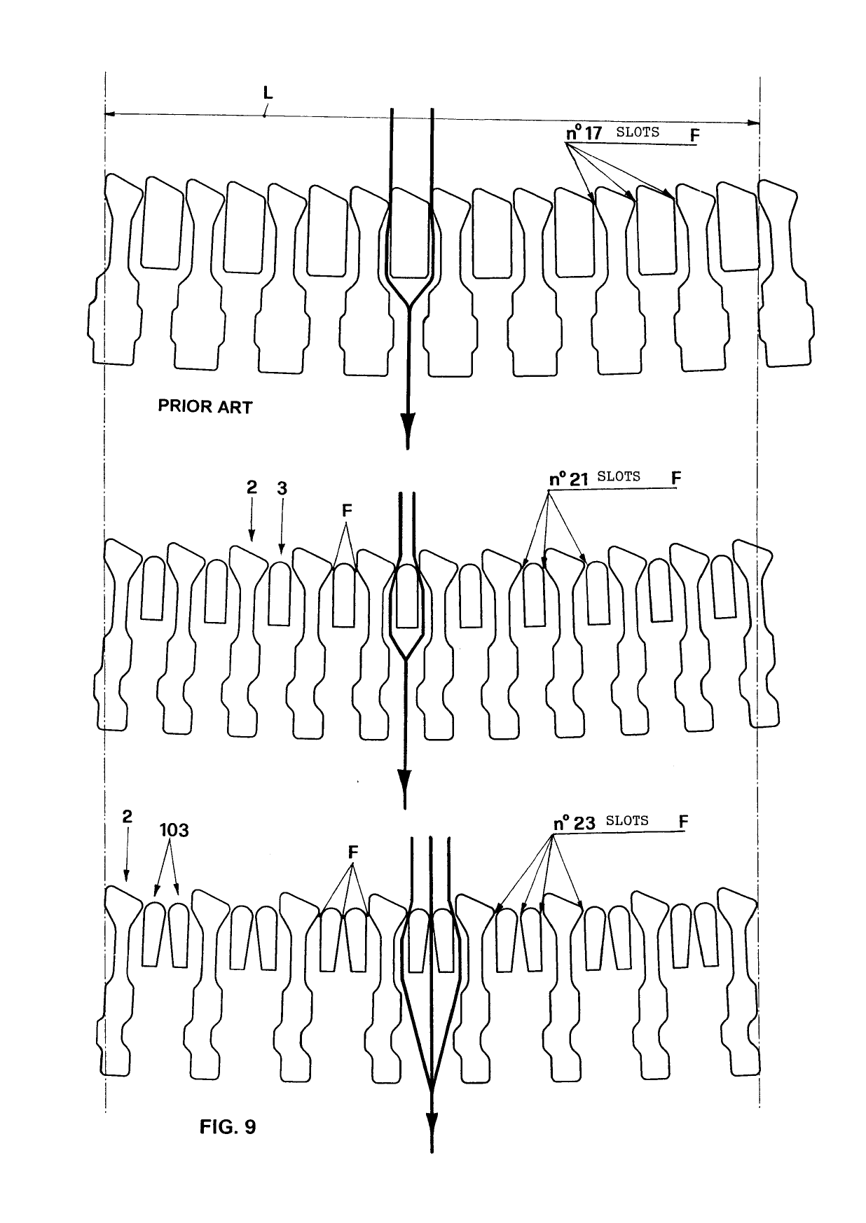

FIG. 8 shows a partial schematic view of a construction variant of the filtering basket of the invention, carried out orthogonally to the longitudinal axis of the basket;

FIG. 9 shows the partial schematic views of both the construction variants of the filtering basket of the invention shown in FIGS. 3 and 8, compared to the partial schematic section of a filtering basket constructed according to the known art as shown in FIG. 1, all carried out orthogonally to the longitudinal axis of the basket.

The filtering basket that is the subject of the invention is shown in axonometric view in FIG. 2, where it is indicated as a whole by 1.

It is applied to machines for filtering fibres in water dispersion and, as shown also in the partial cross section of FIG. 3, it comprises a plurality of profiled bars 2, 3 developing mainly in a longitudinal direction, arranged side by side one against the other, in order to define for such basket 1 a tubular structure with substantially circular cross-section that defines a longitudinal axis X.

Each profiled bar 2, 3, with reference also to FIGS. 4 to 7, comprises a shaped edge 4, 5 facing towards the inside of the basket and a prismatic body 6, 7.

When the profiled bars 2, 3 are arranged side by side, one against the other, so that the respective prismatic bodies 6, 7 are in contact with each other, the corresponding shaped edges 4, 5 are spaced from each other in such a way as to define a plurality of longitudinal slots F that transform the inner lateral surface of the basket 1 into a filtering surface.

A plurality of annular elements 8 coaxial with one another and spaced from one another according to the longitudinal axis X defined by the basket are coupled by interference to the outside of the profiled bars 2, 3, in such a way as to maintain the tubular geometric configuration of the basket 1 unaltered.

It is useful to observe that the annular elements 8, which in the case shown in FIG. 1 are four, may be present in any number, according to the length of the basket.

According to the invention, the profiled bars 2, 3 comprise a plurality of main bars 2, each provided with a shaped edge 4 whose cross-section is in the form of a trapezium, with the long side 4a facing towards the inside of the basket, and a plurality of secundary bars 3, each provided with a shaped edge 5 whose cross-section is in the shape of a curve, with the convex side facing towards the inside of said basket.

As shown in FIGS. 3 to 5, the curved shape of the shaped edge 5 of each secundary bar 3 is an arc of a circle 5a.

It can also be observed that each main bar 2 is included between two secundary bars 3 and that between each pair of main bars 2 there is a secundary bar 3.

Substantially, therefore, the profiled bars are arranged so that each main bar 2 is followed by a secundary bar 3, in a continuous sequence according to the circumference that defines the lateral surface of the filtering basket.

In particular, in the cross-section of the filtering basket shown in FIGS. 4 and 5, it can be observed that the direction D1 defined by the segment that constitutes the long side 4a of the trapezium-shaped edge 4 of each main bar 2, forms angles α1, α2, different from right angles, with the direction D2 coplanar to it defined by the segment that joins the longitudinal axis X of the basket with any of the points P of the long side 4a.

Furthermore, it is possible to identify a first circumference C1 tangential to the shaped edge 4 of the main bars 2 and a second circumference C2 tangential to the shaped edge 5 of the bars 3, both having their centre on the longitudinal axis X, wherein the radius R2 of the second circumference C2 is longer than the radius R1 of the first circumference C1.

In this way a plurality of recesses 9 is defined in the basket 1, said recesses being included between the sides of the shaped edges 4 of each pair of main bars 2 adjacent to each other and the circumferences C1 and C2.

Each recess 9, indicated by a broken line in FIGS. 4 and 5, has substantially he form of a trapezium with two right angles in which the obtuse angle β1 and the right angle β2 adjacent to the short side 9a are each arranged at the level of a corresponding slot F.

Tests performed on prototypes have shown that in each recess 9, indicated by a broken line in FIGS. 4 and 5, a single vortex V is created, which affects both the slots F defined between the secundary bar 3 and the main bars 2 adjacent to it.

The profile 5a of the shaped edge 5 of each secundary bar has the shape of an arc of a circle and is housed approximately at the height of the short side 9a of the trapezium-shaped recess 9, thus allowing the main bars 2 to be moved near each other.

Furthermore, the thickness of the secundary bars 3 can be reduced to a minimum value compatible with the mechanical resistance conditions, thus obtaining slots F that are very near each other and are both affected by a single vortex V.

In this way the invention also achieves the object to increase the number of slots F per unit of surface compared to the known art, thus increasing the filtering capacity of the basket even if it has the same size as the filtering baskets of the known art.

The prototypes that have been constructed have made it possible to verify, as is shown in FIG. 9, that in the same circumferential unit of length L, if the basket is constructed according to the known art there are 17 slots F, while if the basket is constructed according to the embodiment illustrated in FIGS. 3 to 5 there are 21 slots F.

It can also be observed that in each recess 9 angles β1 and β2 are created for the inlet of the fluid in the respective slots F, said angles being different from each other, so that it is possible to differentiate the filtration of the fluid in two separate slots instead of in a single slot, as is the case with the baskets constructed according to the known art shown in FIG. 1.

Each profiled bar 2, 3, as can be observed also in FIGS. 4, 6 and 7, comprises an intermediate section 10, 11 that connects the prismatic body 6, 7 to the shaped edge 4, 5 and has a thickness, respectively S1, S2, less than the thickness A1, A2 of the corresponding prismatic body 6, 7 and less than or equal to the thickness B1, B2 of the corresponding shaped body 4, 5.

In this way between each pair of profiled bars 2, 3 a conveying channel 12 is defined, which is delimited by the intermediate sections 10, 11, diverges towards the inside of the basket and communicates with a corresponding slot F.

In particular, each intermediate section 10, 11 is delimited by lateral walls 10a, 11a parallel to each other and the thickness Sa of the intermediate section 11 of each secundary bar 3 is equal to the diameter of the arc of a circle 5a that defines the shaped edge 5.

The prismatic bodies 6, 7 of the profiled bars 2, 3 present concavities 6a, 7a and protrusions 6b, 7b that can be matched to each other as shown in FIG. 5 and that serve to permanently constrain the profiled bars to each other, after coupling the annular elements outside them.

A construction variant of the filtering basket of the invention, indicated by 100 in FIG. 2, has the cross-section shown in FIG. 8, in which it is possible to observe that between each pair of main bars 2 there are two secundary bars 103, each one of which has the intermediate section 111 delimited by lateral walls 111a diverging towards the inside of the basket.

In this way, between each pair of main bars 2 three slots F are defined, which are all affected by a single vortex V created between the main bars 2 adjacent to each other.

Also in this case the thickness of the secundary bars 103 can be reduced to very low values compatibly with the possibility to guarantee the necessary mechanical resistance, in such a way as to further concentrate the number of filtering slots F per circumferential unit of length of the basket.

Experimental tests have shown that, as illustrated in FIG. 9, it is possible to further increase the number of slots F until reaching the number of 23 slots on the same circumferential unit of length L.

Furthermore, the three slots F included between each pair of main bars 2 present three different fluid inlet angles β1, β2 and β3.

Therefore, also this construction variants achieves the object to further differentiate the filtration of the fibres on three different slots with three different inlet angles.

The filtering basket carried out according to any of the described variants is constructed so that the profiled bars 2, 3; 103 have different cross-sections along the longitudinal axis X of the basket.

Thus, in FIGS. 6 and 7 it is possible to observe that each one of the main bars 2 has a constant cross-section along the longitudinal direction X and is flanked by a secundary bar 3; 103 whose cross-section varies along the same longitudinal direction X, since the prismatic bodies 7, 107 have C-shaped hollow areas 3a, 103a that are visible in FIG. 6 and face towards the outside of the basket.

This particular embodiment can be carried out both in the case where in each pair of main bars 2 there is a single secundary bar 3 and in the case where said secundary bars 103 are two.

In this way, draining chambers 13; 113 are defined inside the basket, thus improving the filtration of the fibrous suspension as regards both the filtering quality and the flow rate of the filtered fluid.

In fact, the presence of the draining chambers 13, 113 allows each slot F to be restricted while maintaining for the basket in its whole a satisfying flow rate of solution filtered through the filtering surface.

The hollow areas 3a, 103a of the bars are obtained in such positions that the draining chambers 13, 113 are included between the annular elements 8 when these are arranged so as to encircle the bars 2, 3; 103 externally.

According to the above, it can thus be understood that the basket that is the subject of the invention, in both the embodiments described, achieves the set objects and offers the described advantages.

In particular, it has been observed that the special configuration and arrangement of the shaped edges of the shaped bars makes it possible to increase the number of slots per circumferential unit of length compared to the baskets carried out according to the known art.

The invention also ensures the advantage that said differentiated slots have differentiated inlet angles, in such a way as to obtain the differentiated and selective filtration of the fibres of the solution.

Furthermore, the creation of hollow areas in the secundary bars makes it possible to maintain good values of flow rate even though the width of the slots is reduced as much as possible, by thinning the bars until reaching the minimum limit compatible with their mechanical resistance.

In the construction stage of the basket that is the subject of the invention changes may be made that are neither described herein nor illustrated in the figures.

It is understood, however, that if these changes fall within the scope of the following claims, they must all be considered protected by the present patent.

Where technical features mentioned in any claim are followed by reference signs, those reference sings have been included for the sole purpose of increasing the intelligibility of the claims and accordingly such reference signs do not have any limiting effect on the interpretation of each element identified by way of example by such reference signs.

1. A filtering basket for fibres in water dispersion, comprising:
a plurality of profiled bars that develop in a mainly longitudinal direction and are arranged parallel to one another and side by side to define a tubular structure with a substantially circular cross-section and an inner lateral surface provided with a plurality of longitudinal slots that define a filtering surface; and
two or more annular elements coaxial to one another and spaced from one another according to the longitudinal axis defined by said tubular structure, coupled by interference outside said profiled bars, wherein said profiled bars comprise
a plurality of main bars, each one of which is provided with a shaped edge having a first surface and a second surface, with the first surface facing towards the inside of the basket and
a plurality of secondary bars, each one having a shaped edge whose cross-section is curved, with a convex part facing towards the inside of said basket, and
wherein the main bars and the secondary bars are configured so that in a cross-sectional view of the filtering basket:
said shaped edges of said main bars are tangential to a first circumference, and
said shaped edges of said secondary bars are tangential to a second circumference, wherein the second circumference has a radius longer than the radius of the first circumference, and
wherein respective recesses are located between the shaped edges of each adjacent pair of said main bars and the shaped edge of at least one of said secondary bars,
wherein each said recess (in cross section) has substantially the form of a trapezoid, which is delimited by the intersection of the directions defined by the first surface of the shaped edge of one of the main bars of each adjacent pair of main bars, the second surface of the shaped edge of the other main bar of each adjacent pair of main bars, and said first and second circumferences,
wherein the angles between a short side of said recess trapezoid and adjacent sides of the recess trapezoid are different from one another.

2. A filtering basket according to claim 1, wherein each one of said main bars is included between two of said secondary bars.

3. A filtering basket according to claim 1, wherein between each pair of said main bars there is one of said secondary bars.

4. A filtering basket according to claim 1, wherein between each pair of said main bars there are two of said secondary bars.

5. A filtering basket according to claim 1, wherein a long side direction defined by the first surface of the shaped edge of each one of said main bars and the direction coplanar to said long side direction and defined by a segment that joins said longitudinal axis with any point of said first surface form angles that are not right angles.

6. (canceled)

7. A filtering basket according to claim 1, wherein said curved shape of said shaped edge of each one of said secondary bars is an arc of a circle.

8. A filtering basket according to claim 1, wherein each one of said profiled bars comprises a prismatic body, said profiled bars being arranged one against the other at the level of said respective prismatic bodies in order to define said slots between said shaped edges.

9. A filtering basket according to claim 8, wherein each one of said profiled bars comprises an intermediate section that connects said prismatic body to said shaped edge and whose thickness is less than the thickness of said prismatic body and less than or equal to the thickness of said shaped edge.

10. A filtering basket according to claim 9, wherein between each adjacent pair of said profiled bars a conveying channel is defined, which diverges towards the inside of said basket, is delimited by said intermediate sections, and communicates with a corresponding slot.

11. A filtering basket according to claim 9, wherein said intermediate sections of each one of said profiled bars is delimited by parallel lateral walls.

12. A filtering basket according to claim 9, wherein said intermediate section of said secondary bars is delimited by lateral walls diverging towards the inside of said basket.

13. A filtering basket according to claim 8, wherein said prismatic bodies of said profiled bars have concavities and projections that can be matched to permanently constrain said profiled bars after coupling said annular elements.

14. A filtering basket according to claim 8, wherein said thickness of said shaped edge of each one of said secondary bars is less than the thickness of said shaped edge of each one of said main bars.

15. (canceled)

16. A filtering basket according to claim 1, wherein said recess substantially has the form of a trapezoid with two right angles, where an obtuse angle and a right angle between the short side of the recess and adjacent edges of the recess are arranged at the level of one of said slots.

17. A filtering basket according to claim 8, wherein each one of said main bars has a constant cross-section along a direction parallel to said longitudinal axis and is flanked by one of said secondary bars, wherein each secondary bar includes at least one C-shaped hollow area, thereby causing the cross-section of the prismatic body of each secondary bar to vary along said direction parallel to said longitudinal axis.
